(19) United States
(12) Patent Application Publication
(10) Pub. No.: US 2018/0149570 A1
(43) Pub. Date: May 31, 2018

(54) SILAGE DENSITY PROBE

(71) Applicant: Diamond V Mills, Incorporated, Cedar Rapids, IA (US)

(72) Inventors: Tom OELBERG, New Ulm, MN (US); Todd FRANZ, Bingham Lake, MN (US)

(21) Appl. No.: 15/827,741

(22) Filed: Nov. 30, 2017

Related U.S. Application Data
(60) Provisional application No. 62/428,149, filed on Nov. 30, 2016.

(51) Int. Cl. G01N 9/36; A01F 25/20

(52) U.S. Cl. CPC G01N 9/36; A01F 25/20

(57) ABSTRACT

A silage density measuring device that is insertable into a mass of silage. The device comprises a probe that penetrates the mass of silage a certain distance. A load cell is connected to the probe and measures an amount of force needed to insert the probe the distance into the mass of silage. The amount of force is utilized to give a density of the silage and the amount is shown on a display monitor. The device is mountable on a load bucket which assists in avoiding accidents involving silage avalanches.

### CROSS-REFERENCE TO RELATED APPLICATIONS

This application claims priority to U.S. Provisional Application No. 62/428,149 filed on Nov. 30, 2016, the contents of which are hereby incorporated by reference herein.

### BACKGROUND OF THE INVENTION

The present invention relates to determining pack density of wet feeds stored in bunkers, drive-over piles and plastic bags. Silage is fermented, high-moisture stored fodder that is typically fed to farm animals. Alternatively, silage can be utilized as a biofuel feedstock for anaerobic digesters. While silage is usually made from grass crops, silage can be made from a variety of field crops.

As the silage is stored, it can be piled up in a particular location until needed. Silage must be firmly packed to minimize the oxygen content, therefore, mitigating its ability to spoil. Accordingly, at times, certain characteristics, such as pack density, of the silage must be determined. The current art requires core sampling of the wet feeds and puts workers in danger of silage avalanches that can cause serious bodily injury and even death. Furthermore, the core sampling method requires weighing the silage samples and determining moisture levels. These requirements lead to the need for additional time and costs.

It is an object of the invention to provide a device that can measure density of silage from a distance.

It is further an object of the invention to provide a device that can measure pack density instantly.

### SUMMARY OF THE INVENTION

The present invention is a device for measuring silage density. The silage density device has a probe that determines the density of silage by measuring the amount of force to push the probe into a vertical face of a pile of silage. The probe is attached to a load cell that measures the force needed to push the probe a particular distance into the wet feed or silage. The probe can easily be attached to a loader bucket of a farm tractor or other piece of machinery.

The probe is attached to a load cell that is attached to a frame. The frame has two cross members to help support the load cell and probe shaft while the device is in use. The parts of the device are made of materials that can withstand the forces generated on the probe and frame when the device is inserted into the silage. Preferably the materials are metal or rigid plastics.

### BRIEF DESCRIPTION OF THE SEVERAL VIEWS OF THE DRAWING(S)

FIG. 1 is a perspective view of a silage density probe;

FIG. 2 is a top view of the probe;

FIG. 3 is a side view of the probe;

FIG. 4 is a perspective view of the probe with the display component;

FIG. 5 is a perspective view of the probe mounted on a bucket of a tractor.

### DETAILED DESCRIPTION OF THE INVENTION

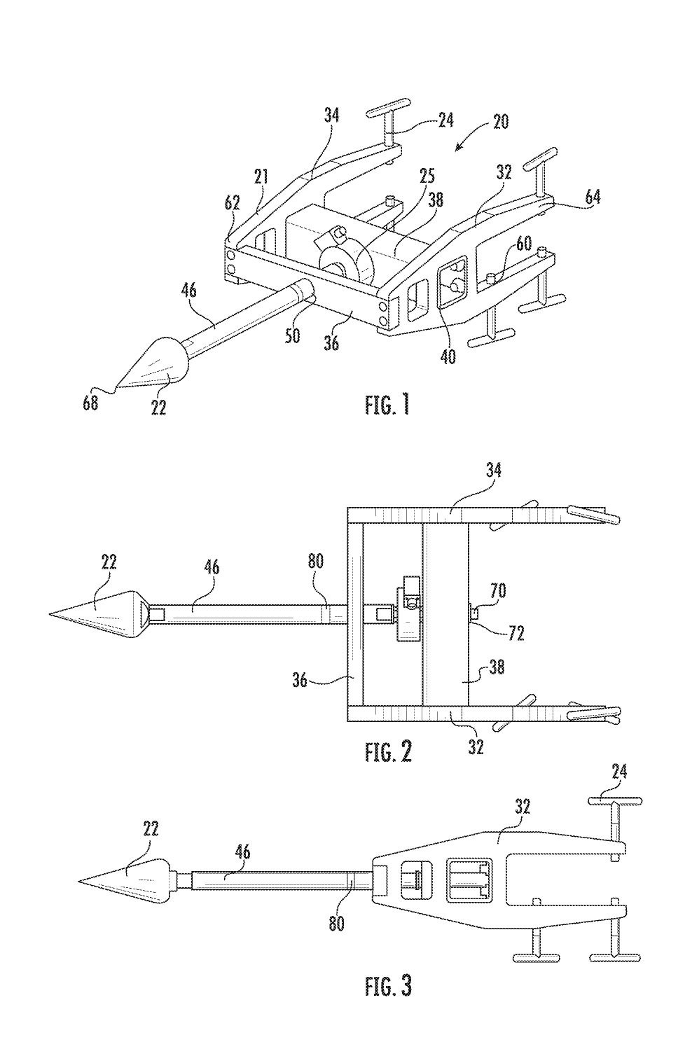

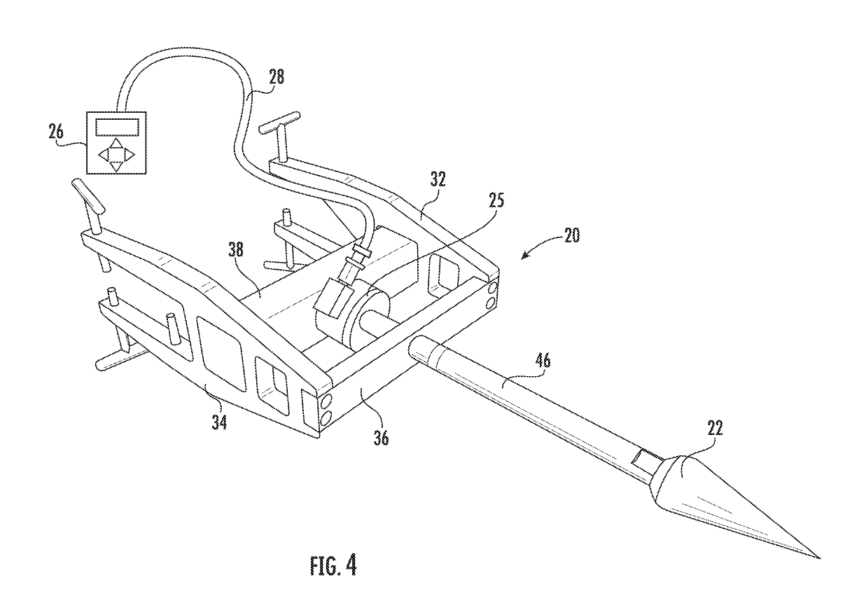

FIGS. 1 through 4 show a silage density measuring device 20 used for measuring the density of a pile of silage. The device 20 comprises a probe 22 and a frame 21. A loading bucket of a typical farm tractor as shown in FIG. 6 can be attached to the frame 21 via fastening mechanisms such as brackets 24. The device further comprises a mechanism for measuring a particular force, the preferred embodiment utilizes load cell 25. Additionally, the load cell 25 is connected to a display monitor 26 via a cable 28 so the amount of force can be viewed by a user of the device 20. A gauge 30 can be attached to the device 20 or in particular to the probe 22 to check for levelness of the probe 22.

As shown in FIGS. 1-3, the frame 21 comprises a first side plate 32 and a second side plate 34. The frame 21 further comprises a first support member 36 and a second support member 38. The first support member 36 and second support member 38 are attached to the first side plate 32 and second side plate 34 such that they form perpendicular angles to one another. Preferably, the second support member 38 fits within a cavity 40 of the first side plate 32 and a cavity 40 of the second side plate 34. The cavities 40 are preferably square and the second support member 38 has a complimentary shape to fit within the cavities 40. The parts of the frame 21 are attached to one another with fastening mechanisms such as screws, bolts and washers.

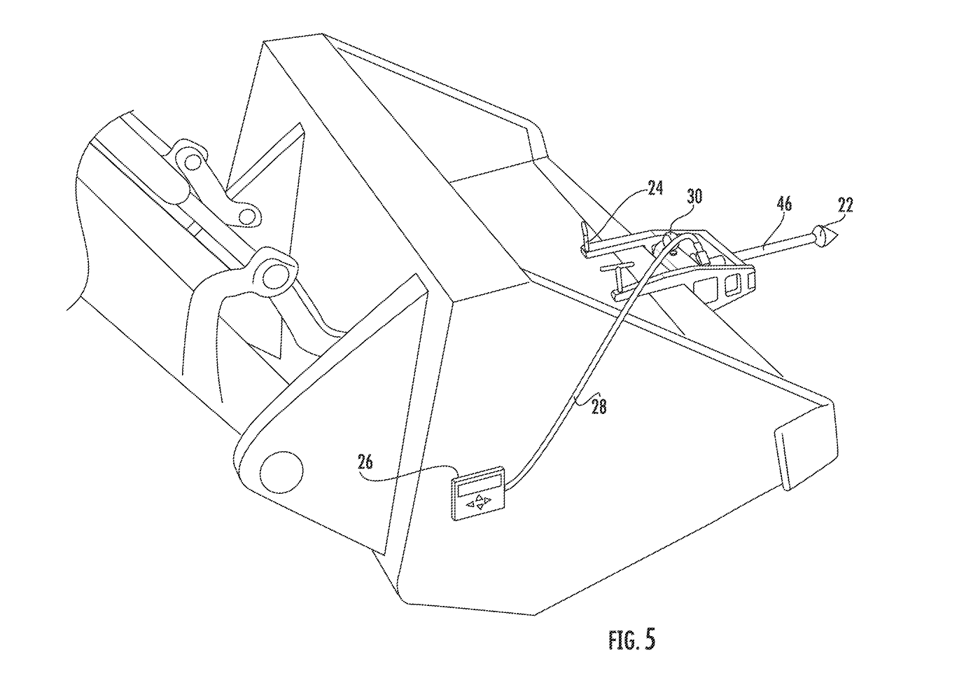

The first side plate 32 and second side plate 34 each have a first end 62 and second end 64. Toward or at the second end 64, the brackets 24 which can be clamps are threaded through openings 60 in the first side plate 32 and second side plate 34. The plurality of brackets 24 are tightened such that they can be clamped onto a secondary piece of equipment such as a bucket of a typical farm tractor as shown in FIG. 5. The first support member 36 has an opening 50 through which a probe shaft 46 can be fitted. The probe shaft 46 is connected to the probe 22 and the load cell 25. Preferably the load cell 25 is a compression load cell that can bend or a pancake load cell. The probe 22 has a tip 68. The load cell 25 is attached to the frame 21, preferably to the second support member 38, via a fastener 70 such as a bolt and a washer 72.

In practice, the device 20 is selectively attached to a bucket of a farm tractor utilizing the brackets 24. Once attached, the tip 68 of probe 22 is pointing outward from the bucket. The cable 28 can be of a sufficient length for the display monitor 26 to be in the cab of the farm tractor. While FIG. 5 shows the display monitor 26 near the bucket, the preferred embodiment has the display monitor in the cab such that a user of the farm tractor can read the display while seated in the cab. The use of the device 20 can then drive the farm tractor to make contact with a particular pile of silage with the probe 22. The probe 22 and probe shaft 46 can be entered a desired distance into the silage. A depth marker 80 is on the probe shaft 46 and assists in determining the depth of the probe shaft 46 in the silage. The contact of the probe 22 with the silage causes a force to be exerted against the load cell 25 which is then shown on the display monitor 26. The density of the silage can be calculated by plugging the force value into a linear regression equation. Certain values of the silage, including density, can be determined and shown on the display monitor 26.

The foregoing description of the invention has been presented for purposes of illustration and description and is not intended to be exhaustive or to limit the invention to the precise form disclosed. Modifications and variations of the embodiments are possible in light of the above disclosure or such may be acquired through practice of the invention. The embodiments illustrated were chosen in order to explain the principles of the invention and its practical application to enable one skilled in the art to utilize the invention in various embodiments and with various modifications as are suited to the particular use contemplated. It is intended that the scope of the invention be defined by the claims appended hereto, and by their equivalents.

Having described the invention, we claim:

1. A silage density measuring device, comprising:
a probe;
a load cell;
the probe connected to the load cell;
the device adapted to attach to a secondary piece of equipment;
wherein the load cell measures an amount of force required to insert the probe into an amount of silage;
wherein the amount of force is utilized to calculate a density of the silage.

2. The silage density measuring device of claim 1, further comprising:
a frame;
wherein the frame is attachable to the secondary piece of equipment.

3. The silage density measuring device of claim 2, further comprising:
a display monitor;
wherein the display monitor displays the amount of force required to insert the probe into the amount of silage;
wherein the density can be calculated from a linear regression equation.

4. The silage density measuring device of claim 3, further comprising:
at least one fastening mechanism;
wherein the fastening mechanism is adapted to attach the device to the secondary piece of equipment.

5. The silage density measuring device of claim 4, wherein:
the load cell is a compression load cell that can bend.

6. The silage density measuring device of claim 5, further comprising:
a probe shaft;
wherein the probe shaft links the probe to the load cell.

7. The silage density measuring device of claim 6, wherein:
the probe has a tip.

8. The silage density measuring device of claim 7, wherein:
the frame comprises at least one side frame;
the frame further comprises at least one support member.

9. The silage density measuring device of claim 8, wherein:
the at least one side frame is perpendicular to the at least one support member.

10. The silage density measuring device of claim 9, wherein:
a first support member has an opening to accommodate the probe shaft.

11. The silage density measuring device of claim 10, wherein:
a second support member is attached to the load cell.

12. The silage density measuring device of claim 11, wherein:
the display monitor is attached to the load cell via a cable;
wherein the cable of a sufficient length such that the display monitor can be mounted on a cab of the secondary piece of equipment.

13. A silage density measuring device, comprising:
a probe;
a load cell;
the probe connected to the load cell;
the device adapted to attach to a secondary piece of equipment;
a display monitor;
the display monitor is attached to the load cell via a cable;
wherein the cable of a sufficient length such that the display monitor can be mounted on a cab of the secondary piece of equipment
wherein the load cell measures an amount of force required to insert the probe into an amount of silage;
wherein the amount of force is utilized to calculate a density of the silage;
wherein the display monitor displays the amount of force required to insert the probe into the amount of silage.

14. The silage density measuring device of claim 13, further comprising:
a frame;
wherein the frame is attachable to the secondary piece of equipment.

15. The silage density measuring device of claim 14, wherein:
the load cell is a pancake load cell.

16. The silage density measuring device of claim 15, wherein:
at least one fastening mechanism;
wherein the fastening mechanism is adapted to attach the device to the secondary piece of equipment.

17. The silage density measuring device of claim 16, wherein:
the frame comprises at least one side frame;
the frame further comprises at least one support member.

18. The silage density measuring device of claim 17, wherein:
the at least one side frame is perpendicular to the at least one support member.

19. The silage density measuring device of claim 18, further comprising:
a probe shaft;
the probe shaft links the probe to the load cell.

20. A silage density measuring device, comprising:
a probe;
the probe having a tip;
a load cell;
the probe connected to the load cell via a probe shaft;
a frame;
the load cell attached to the frame;
the device adapted to attach to a secondary piece of equipment;
a display monitor;
the display monitor is attached to the load cell via a cable;
wherein the cable of a sufficient length such that the display monitor can be mounted on a cab of the secondary piece of equipment
wherein the load cell measures an amount of force required to insert the probe into an amount of silage;
wherein the amount of force is utilized to calculate a density of the silage;
wherein the display monitor displays the amount of force required to insert the probe into the amount of silage.
